(19) United States
(12) Patent Application Publication
(10) Pub. No.: US 2012/0033779 A1
(43) Pub. Date: Feb. 9, 2012

(54) METHODS OF DETERMINING IN-REACTOR SUSCEPTIBILITY OF A ZIRCONIUM-BASED ALLOY TO SHADOW CORROSION

(75) Inventors: Daniel Reese Lutz, Sunol, CA (US); Young Jin Kim, Clifton Park, NY (US); Yang-Pi Lin, Wilmington, NC (US)

(73) Assignee: GLOBAL NUCLEAR FUEL - AMERICAS, LLC, Wilmington, NC (US)

(21) Appl. No.: 12/850,244

(22) Filed: Aug. 4, 2010

(51) Int. Cl. G21C 17/00

(52) U.S. Cl. 376/259

(57) ABSTRACT

A method of determining in-reactor susceptibility of a zirconium-based alloy to shadow corrosion according to a non-limiting embodiment of the present invention may include immersing a first electrode and a second electrode in an electrolytic solution. The first electrode may be formed of the zirconium-based alloy, while the second electrode may be formed of a metallic material suitable for use in a nuclear reactor and having a higher electrochemical corrosion potential than the zirconium-based alloy. The method may additionally include irradiating the immersed first and second electrodes with electromagnetic radiation. A galvanic current may then be measured between the first electrode and the second electrode to ascertain the relative in-reactor susceptibility of the zirconium-based alloy to shadow corrosion. The present invention allows a simplified and more rapid method of developing solutions that mitigate shadow corrosion, thereby potentially saving years of expensive in-reactor testing.

### BACKGROUND

1. Field

The present disclosure relates to methods for determining the occurrence of corrosion on materials within a reactor core during the operation of a nuclear reactor.

2. Description of Related Art

A form of radiation enhanced corrosion known as “shadow corrosion” has been known to adversely affect zirconium-based alloys within a reactor core during the operation of a nuclear reactor. The exact mechanism for shadow corrosion is not known, but the corrosion has been observed when a zirconium-based alloy is proximate to or in direct contact with a dissimilar metal in a reactor.

Shadow corrosion is a performance and reliability concern in the nuclear industry. However, shadow corrosion has only been observed during in-reactor operation and has not been demonstrated to occur in laboratory environments. As a result, the development of mitigating designs is cumbersome, time consuming, and expensive, because such development necessarily involves in-reactor testing.

### SUMMARY

A method of determining in-reactor susceptibility of a zirconium-based alloy to shadow corrosion according to a non-limiting embodiment of the present invention may include immersing a first electrode and a second electrode in an electrolytic solution. The first electrode may be formed of the zirconium-based alloy, while the second electrode may be formed of a metallic material suitable for use in a nuclear reactor and having a higher electrochemical corrosion potential than the zirconium-based alloy. The method may additionally include irradiating the immersed first and second electrodes with electromagnetic radiation; and measuring a galvanic current between the first electrode and the second electrode to ascertain the relative in-reactor susceptibility of the zirconium-based alloy to shadow corrosion.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For purposes of clarity, various dimensions of the drawings may have been exaggerated.

FIG. 1A illustrates a stainless steel control blade handle shadow on an outer surface of a Zircaloy channel, wherein the dark lines depict the approximate dimension of the control blade handle.

FIG. 1B illustrates the oxide thickness within a control blade handle shadow region.

FIG. 1C illustrates the oxide thickness away from a control blade handle shadow region.

FIG. 2 illustrates a method of determining in-reactor susceptibility of a zirconium-based alloy to shadow corrosion according to a non-limiting embodiment of the present invention.

FIG. 3 illustrates the effect of UV illumination on corrosion potential behavior of NSF, Zircaloy-4, Ziron, and X750 electrodes in 0.01 M Na₂SO₄ solution at 25° C., wherein test electrodes have been pre-immersed for 4 weeks in 300° C. water containing 1.1 ppm O₂, according to a non-limiting embodiment of the present invention.

FIG. 4 illustrates the galvanic current response of NSF and X750 coupling in 0.01 M Na₂SO₄ at 25° C. (with and without UV illumination) according to a non-limiting embodiment of the present invention.

FIG. 5 illustrates the galvanic current of NSF or Ziron coupled with Alloy X-750 in 300° C. water containing 1.1 ppm O₂ (with and without UV illumination) according to a non-limiting embodiment of the present invention.

### DETAILED DESCRIPTION

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It should be understood that, although the terms first, second, third, etc. may be used herein to describe various elements, components, regions, layers and/or sections, these elements, components, regions, layers, and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

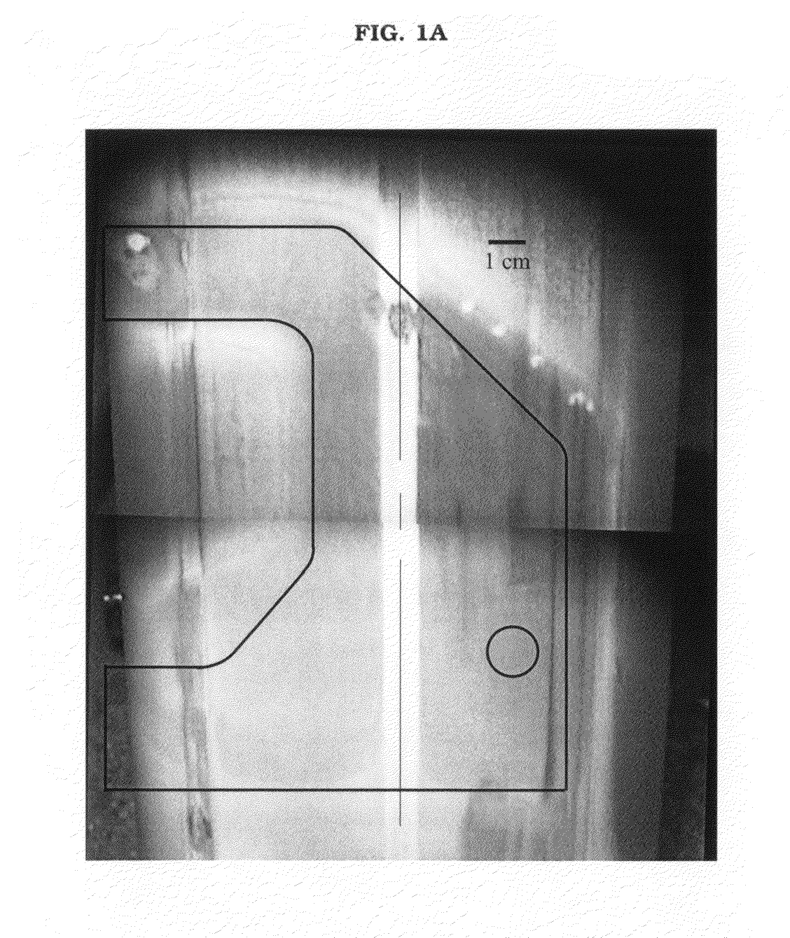

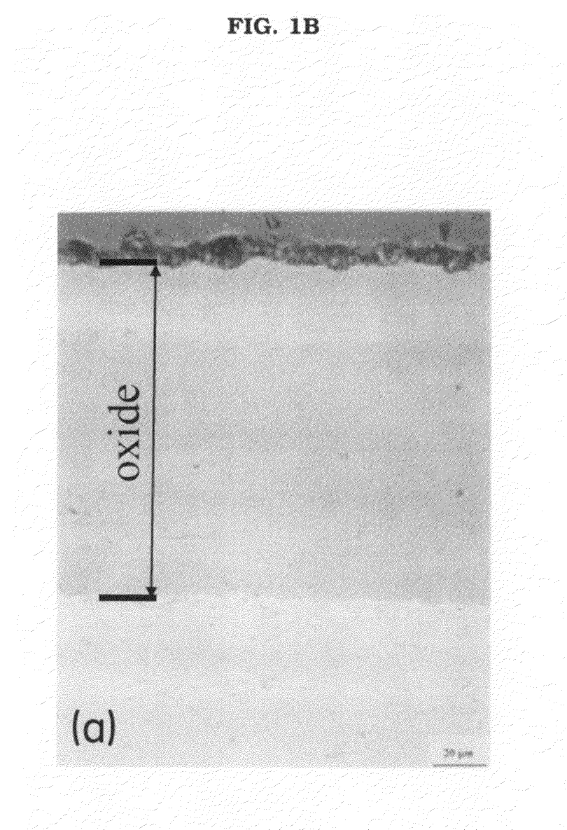

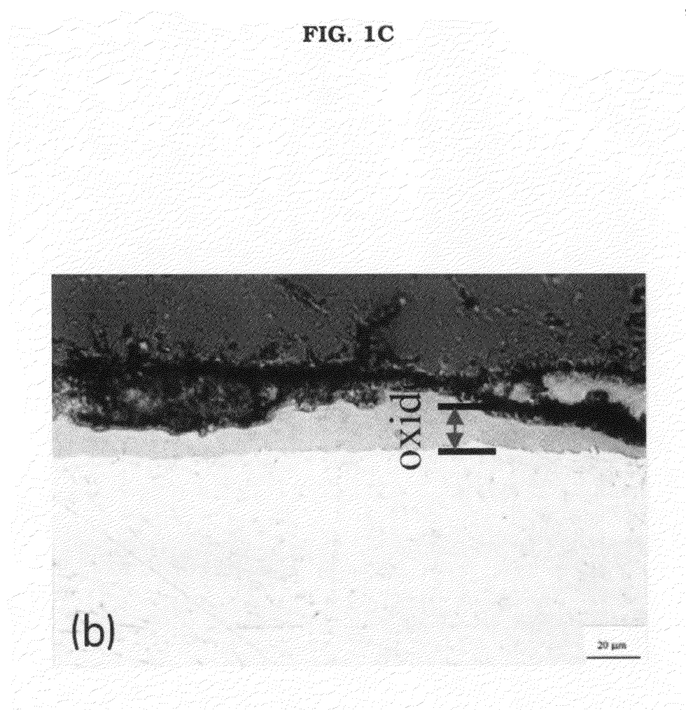

Example embodiments of the present invention relate to methods of determining in-reactor susceptibility of a zirconium-based alloy to shadow corrosion. The shadow corrosion of a zirconium-based alloy is illustrated, for instance, in FIGS. 1A-1C.

A method of determining in-reactor susceptibility of a zirconium-based alloy to shadow corrosion may include immersing a first electrode and a second electrode in an electrolytic solution. The first electrode may be formed of the zirconium-based alloy, while the second electrode may be formed of a metallic material suitable for use in a nuclear reactor and having a higher electrochemical corrosion potential than the zirconium-based alloy. The method may additionally include irradiating the immersed first and second electrodes with electromagnetic radiation; and measuring a galvanic current between the first electrode and the second electrode to ascertain the relative in-reactor susceptibility of the zirconium-based alloy to shadow corrosion.

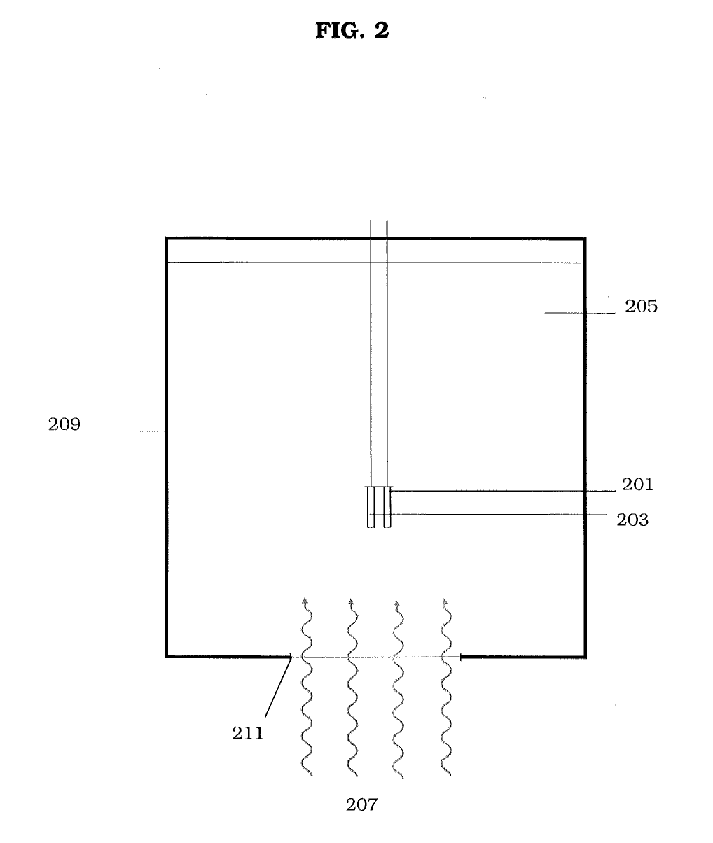

FIG. 2 illustrates a method of determining in-reactor susceptibility of a zirconium-based alloy to shadow corrosion according to a non-limiting embodiment of the present invention. Referring to FIG. 2, a first electrode 201 and a second electrode 203 are immersed in an electrolytic solution 205. After immersion, the first and second electrodes 201 and 203 are irradiated with electromagnetic radiation 207. A galvanic current is then measured between the irradiated first and second electrodes 201 and 203 to ascertain the relative in-reactor susceptibility of the zirconium-based alloy to shadow corrosion.

The first electrode 201 may be formed of the zirconium-based alloy. The zirconium-based alloy may contain at least 95 percent zirconium by weight. The zirconium-based alloy may also include niobium. For instance, the zirconium-based alloy may be Zircaloy-2 or Zircaloy-4, although example embodiments are not limited thereto.

The second electrode 203 may be formed of a metallic material suitable for use in a nuclear reactor and having a higher electrochemical corrosion potential than the zirconium-based alloy. The second electrode 203 may be an iron-based alloy. For instance, the iron-based alloy may be stainless steel. Alternatively, the second electrode 203 may be a nickel-based alloy. The nickel-based alloy may include more than about 50 percent nickel by weight. For instance, the nickel-based alloy may be Inconel (e.g., X-750). In yet another non-limiting embodiment, the second electrode 203 may be formed of platinum. Although various materials have been identified above for illustrative purposes, it should be understood that other materials that are suitable for use in a nuclear reactor and that have a higher electrochemical corrosion potential than the zirconium-based alloy may also be used to form the second electrode 203.

The first electrode 201 and the second electrode 203 are arranged within an autoclave 209. The first electrode 201 may be arranged within a distance of about 0 to 100 mm to the second electrode 203. Also, each of the first and second electrodes 201 and 203 may have an oxide layer formed thereon.

The electrolytic solution 205 may be an ionic solution. Without being limited by the following examples, the electrolytic solution 205 may be at least one of a salt solution, deionized water, distilled water, and water with a resistance greater than 10 Mohm. When the electrolytic solution 205 is a salt solution, the salt may be sodium sulfate or sodium chloride. The electrolytic solution 205 may be at a temperature between about 20 and 400 degrees Celsius. Furthermore, the pressure within the autoclave 209 may be within a range of about 0 to 2000 psig.

The electromagnetic radiation 207 may be irradiated into the autoclave 209 through a sapphire window 211, although example embodiments are not limited thereto. The electromagnetic radiation 207 should be at a level sufficient to excite electrons in the oxide layer of the first and second electrodes 201 and 203 to the conduction band. The electromagnetic radiation 207 may be ultraviolet light (UV). Thus, in a non-limiting embodiment, the wavelength of the electromagnetic radiation 207 is shorter than that of visible light, in the range of about 10 nm to 400 nm. In particular, the electromagnetic radiation 207 may have a wavelength between about 200 to 400 nm, although example embodiments are not limited thereto. The ultraviolet light may be irradiated at an intensity of about 1 mW/cm² to 50 W/cm². The irradiation period is not particularly limited thereto as long as a galvanic current between the first electrode 201 and the second electrode 203 can be adequately measured.

Without being bound by theory, the UV radiation appears to be sufficient to simulate the broad radiation spectrum that exists in-reactor but that is absent in normal laboratory corrosion tests. Consequently, the UV radiation appears to promote an enhanced electrochemical potential difference between the first and second electrodes 201 and 203 that is substantially lower in the absence of the radiation.

To ascertain the relative in-reactor susceptibility of the zirconium-based alloy to shadow corrosion, the measured galvanic current between the first electrode 201 and the second electrode 203 is compared with a reference value derived from measurements of a reference set of materials. With regard to structure and arrangement, the reference set of materials may be analogous to the first and second electrodes 201 and 203. With regard to material, the reference set of materials may be a pairing of identical zirconium-based materials. For instance, the identical zirconium-based reference materials may be Zircaloy materials, although example embodiments are not limited thereto. Alternatively, the reference set of materials may be dissimilar materials with a known susceptibility to shadow corrosion.

When the reference set of materials are formed of identical materials, the zirconium-based alloy may be deemed to be susceptible to in-reactor shadow corrosion if the measured galvanic current between the first electrode 201 and the second electrode 203 exceeds the reference value provided by the reference set of materials. More particularly, the zirconium-based alloy may be deemed to be less favored for in-reactor use if the measured galvanic current exceeds a threshold value. For instance, the threshold value may be closer to measurements based on a Zircaloy/stainless steel pairing or a Zircaloy/Inconel pairing than measurements based on a Zircaloy/Zircaloy pairing. Stated more clearly, a Zircaloy/stainless steel pairing or a Zircaloy/Inconel pairing is known to result in the in-reactor shadow corrosion of the Zircaloy. That being said, the galvanic current measured between the first electrode 201 and the second electrode 203 may help predict the susceptibility of the zirconium-based alloy to shadow corrosion based on its relative magnitude to the reference value.

In sum, based on information obtained from pairings known to result in the in-reactor shadow corrosion, new zirconium-based alloys and/or coatings that reduce or prevent the occurrence of shadow corrosion may be developed and tested with greater ease. In sum, the present invention allows a simplified and more rapid method of developing solutions that mitigate shadow corrosion, thereby potentially saving years of expensive in-reactor testing.

To enhance the comprehension and appreciation of the present invention by those ordinarily-skilled in the art, the following description has been provided to detail the photoelectrochemical investigation of radiation enhanced shadow corrosion phenomenon conducted by the inventors.

The present invention is based on photoelectrochemical investigation of various alloys such as Zircaloy 4, NSF, Ziron, 304 stainless steel (SS), and Alloy X-750 in 0.01 M Na₂SO₄ at 25° C. or in high purity water at 300° C. under intense ultraviolet (UV) illumination. UV was selected because its photon energy (˜5 eV) is similar to the energy gap of the electron-hole pairs in zirconium oxide. The data show that the photoexcitation of ZrO₂ caused the corrosion potential to shift in the anodic direction and produced anodic photocurrents under the oxidizing water chemistry condition when a zirconium alloy electrode was galvanically coupled with dissimilar electrodes, such as Alloy X-750, 304 SS, or Pt, causing accelerated corrosion of the zirconium alloy. Without being bound by theory, it is thus postulated that photoelectrochemical enhancement of surface reaction kinetics at the ZrO₂ surface may be responsible for the radiation enhanced corrosion on Zircaloy (i.e., shadow corrosion).

In operating BWRs, accelerated growth of ZrO₂ has been observed on a Zr alloy when it is in close proximity to a dissimilar material (e.g., Alloy X-750 and stainless steel). This anomalous oxide growth is called “shadow corrosion” since the pattern of the enhanced corrosion resembles the shape of the adjacent metallic components.

An example of shadow corrosion on a Zircaloy channel due to an adjacent control blade handle is shown in FIG. 1A. Metallographic examination of shadow corrosion reveals a uniformly enhanced corrosion of the Zr alloys, as shown in FIG. 1B. FIG. 1B illustrates the oxide thickness within a region of Zircaloy channel affected by control blade handle shadow. FIG. 1C illustrates the oxide thickness away from such a region.

Although shadow corrosion has been observed after in-reactor operation, the demonstration of shadow corrosion in the laboratory environments has not been readily achievable. The susceptibility of zirconium alloys to shadow corrosion was investigated by evaluating the photoelectrochemical corrosion characteristics of Zr and other alloys under UV irradiation.

FIG. 2 illustrates a method of determining in-reactor susceptibility of a zirconium-based alloy to shadow corrosion according to a non-limiting embodiment of the present invention.

Test Procedures

304 SS, Alloy X-750, and Zr alloys (Zircaloy 4, Ziron, and NSF) in sheet form were used. Specimens were polished using a wet 600-grit emery paper. The nominal chemical composition of Zr alloys is listed in Table 1.

TABLE 1
Nominal chemical composition of Zr alloys (in weight %).

| Test Alloys | Sn | Fe | Cr | Ni | Nb | Zr |
|---|---|---|---|---|---|---|
| Zircaloy 4 | 1.3 | 0.2 | 0.1 | | | Balance |
| GNF-Ziron | 1.3 | 0.25 | 0.1 | 0.07 | | Balance |
| GNF-NSF | 1.0 | 0.35 | | | 1.0 | Balance |

Photoelectrochemical response of oxidized surface was evaluated by introducing the UV light to the specimen through optical fiber glass. A schematic view of an autoclave system for electrochemical measurement under UV illumination is shown in FIG. 2.

Electrochemical Corrosion Potential Behavior

For a given water chemistry, the electrochemical corrosion potential (ECP) or corrosion potential is dependent on the oxide surface nature, such as oxide thickness, composition, conductivity, structure, etc.

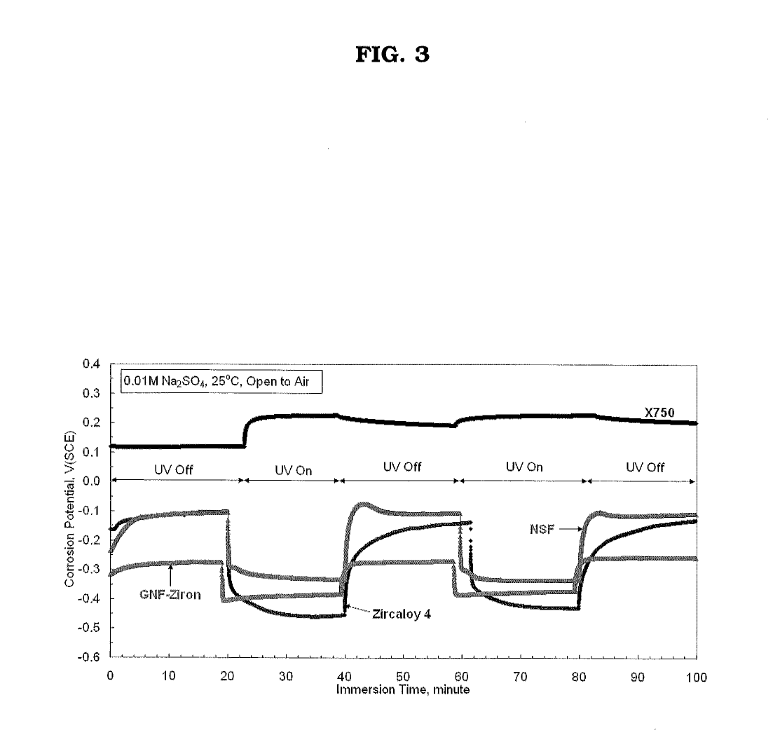

The ECP of three zirconium alloys (Zircaloy-4, Ziron, and NSF) and Alloy X-750 was measured in 0.01 M Na₂SO₄ at 25° C. as shown in FIG. 3. Test specimens were preoxidized for 4 weeks in 300° C. water containing 1.1 ppm O₂. As shown in FIG. 3, when the UV light was turned on, the corrosion potential of zirconium alloys immediately decreased and then increased when the UV illumination stopped. In contrast, the corrosion potential of Alloy X-750 increased when the UV light was turned on. It is known that the oxides become more conductive in the radiation field, since photons at UV and higher energies excite electrons from the valence band to the conduction band where they are free to move.

Therefore, without being bound by theory, it may be postulated that the difference of corrosion potential between zirconium alloys and Alloy X-750 becomes larger in the presence of UV light and consequently enhances the susceptibility of galvanic corrosion between the zirconium alloy and X-750.

Galvanic Corrosion Behavior

Galvanic corrosion may occur when two different metals in contact (or connected by an electrical conductor) are exposed to a conductive solution. A difference in electrical potential exists between different metals, and serves as the driving force to pass current through the metals. This current flow results in increased corrosion of one of the metals in the couple. The larger the potential difference between two metals, the greater the possibility of galvanic corrosion. Note that galvanic corrosion only causes increased deterioration of one of two metals. Galvanic corrosion can often be recognized by the increased amount of corrosion close to the junction of two metals.)

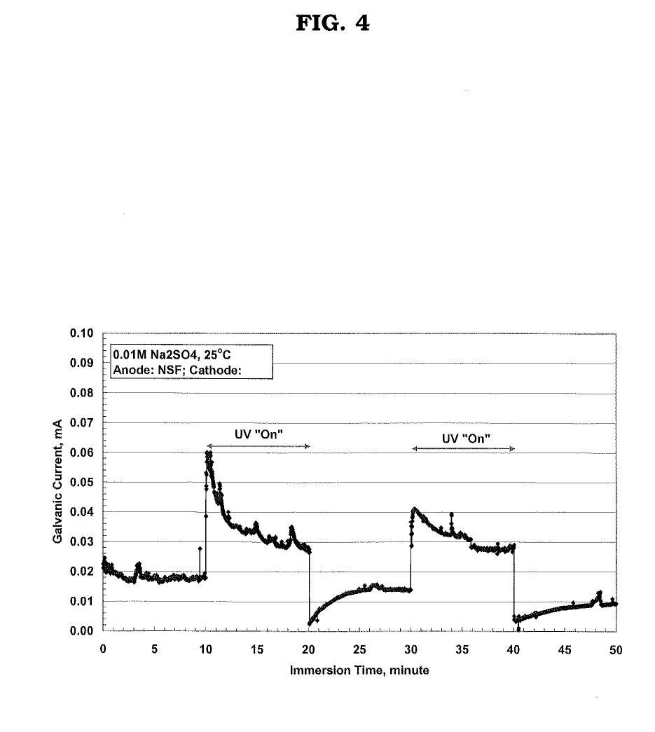

FIG. 4 shows the galvanic current response of NSF coupled with X-750 in 0.01 M Na₂SO₄ at 25° C. All specimens were fully pre-oxidized in 300° C. water as described previously. The anodic electrode is NSF, and the cathodic electrode is X-750. When the coupled specimens were illuminated by the UV light, the galvanic current immediately increased. The positive galvanic current indicates the galvanic current flow from NSF to the X-750 electrode, indicating the anodic corrosion of NSF.

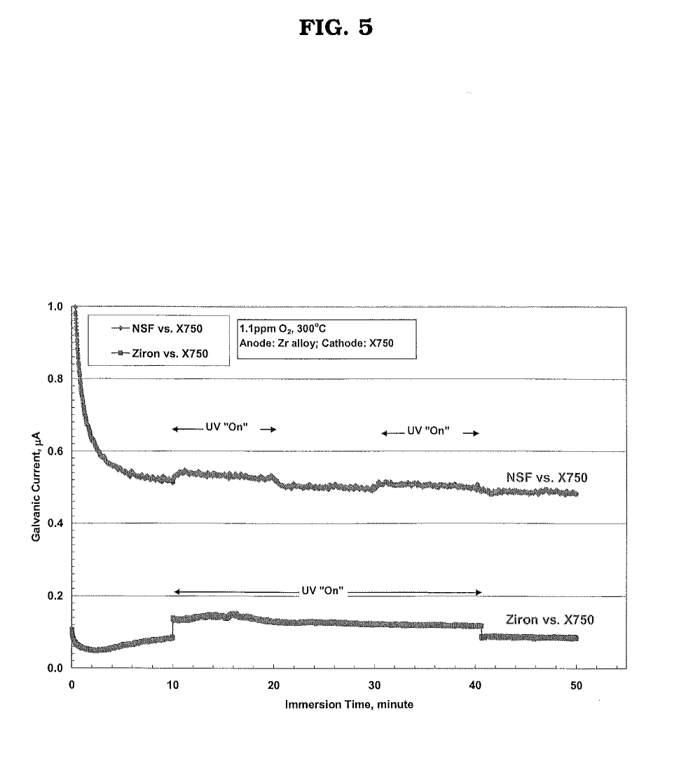

The galvanic current of coupled electrodes was also measured in 300° C. water containing 1.1 ppm O₂ and is shown in FIG. 5. This galvanic current behavior is very similar to one measured at ambient temperature.

FIG. 5 shows the high temperature measurement of galvanic current on two different Zr alloys (Ziron and NSF) coupled with Alloy X-750. Test specimens have been preoxidized under the same water chemistry condition before measuring the galvanic current. It is clearly seen that both Ziron and NSF alloys showed low increases in galvanic current when both alloys were exposed to UV light. These data suggest that both Ziron and NSF alloys may be not strongly sensitive to photoelectrochemical response.

While a number of example embodiments have been disclosed herein, it should be understood that other variations may be possible. Such variations are not to be regarded as a departure from the spirit and scope of the present disclosure, and all such modifications as would be obvious to one skilled in the art are intended to be included within the scope of the following claims.

1. A method of determining in-reactor susceptibility of a zirconium-based alloy to shadow corrosion, the method comprising:
immersing a first electrode and a second electrode in an electrolytic solution, the first electrode being formed of the zirconium-based alloy, the second electrode being formed of a metallic material suitable for use in a nuclear reactor and having a higher electrochemical corrosion potential than the zirconium-based alloy;
irradiating the immersed first and second electrodes with electromagnetic radiation; and
measuring a galvanic current between the first electrode and the second electrode to ascertain the relative in-reactor susceptibility of the zirconium-based alloy to shadow corrosion.

2. The method of claim 1, wherein the first electrode is arranged within a distance of about 0 to 100 mm to the second electrode.

3. The method of claim 1, wherein the zirconium-based alloy contains at least 95 percent zirconium by weight.

4. The method of claim 3, wherein the zirconium-based alloy includes niobium.

5. The method of claim 3, wherein the zirconium-based alloy is Zircaloy-2 or Zircaloy-4.

6. The method of claim 1, wherein the second electrode is an iron-based alloy.

7. The method of claim 6, wherein the iron-based alloy is stainless steel.

8. The method of claim 1, wherein the second electrode is a nickel-based alloy.

9. The method of claim 8, wherein the nickel-based alloy includes more than about 50 percent nickel by weight.

10. The method of claim 1, wherein the second electrode is formed of platinum.

11. The method of claim 1, wherein each of the first and second electrodes has an oxide layer formed thereon.

12. The method of claim 11, wherein the electromagnetic radiation is at a level sufficient to excite electrons in the oxide layer of the first and second electrodes to the conduction band.

13. The method of claim 1, wherein the first electrode and the second electrode are arranged within an autoclave.

14. The method of claim 13, wherein the electromagnetic radiation is irradiated into the autoclave through a sapphire window.

15. The method of claim 13, wherein a pressure within the autoclave is within a range of about 0 to 2000 psig.

16. The method of claim 1, wherein the electrolytic solution is an ionic solution.

17. The method of claim 1, wherein the electrolytic solution is at least one of a salt solution, deionized water, distilled water, and water with a resistance greater than 10 Mohm.

18. The method of claim 17, wherein the salt is sodium sulfate or sodium chloride.

19. The method of claim 1, wherein the electrolytic solution is at a temperature between about 20 and 400 degrees Celsius.

20. The method of claim 1, wherein the electromagnetic radiation has a wavelength between about 200 to 400 nm.

21. The method of claim 1, wherein the electromagnetic radiation is ultraviolet light.

22. The method of claim 21, wherein the ultraviolet light is irradiated at an intensity of about 1 mW/cm² to 50 W/cm².

23. The method of claim 1, wherein the measured galvanic current is compared with a reference value derived from measurements of reference materials.

24. The method of claim 23, wherein the zirconium-based alloy is deemed to be susceptible to in-reactor shadow corrosion if the measured galvanic current exceeds the reference value.

25. The method of claim 23, wherein the reference value results from a pairing of identical zirconium-based reference materials.

26. The method of claim 25, wherein the identical zirconium-based reference materials are Zircaloy materials.

27. The method of claim 23, wherein the zirconium-based alloy is deemed to be less favored for in-reactor use if the measured galvanic current exceeds a threshold value.

28. The method of claim 27, wherein the threshold value is closer to measurements based on a Zircaloy/stainless steel pairing or a Zircaloy/Inconel pairing than measurements based on a Zircaloy/Zircaloy pairing.
